(19) United States
(12) Patent Application Publication
(10) Pub. No.: US 2007/0137937 A1
(43) Pub. Date: Jun. 21, 2007

(54) Conveyor lubricating apparatus

(76) Inventor: Guillermo Citro, Buenos Aires (AR)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 11/288,542

(22) Filed: Nov. 29, 2005

(51) Int. Cl. F16N 7/24

(52) U.S. Cl. 184/17

(57) ABSTRACT

A conveyor lubricating apparatus which includes a roller member to distribute a lubricant on a belt-type conveyor. In one embodiment, the lubricant is dispensed onto a roller which is employed to distribute the lubricant on the belt. In another embodiment, a combined dispensing and roller device distributes the lubricant on the conveyor belt.

### CROSS-REFERENCE TO RELATED APPLICATIONS, IF ANY

Not applicable.

### STATEMENT REGARDING FEDERALLY FUNDED RESEARCH

Not applicable.

### FIELD OF THE INVENTION

This invention relates to a combined conveyor and lubricating apparatus. More particularly, it relates to a combined conveyor and lubricating apparatus wherein roller members distribute a lubricant on a conveyor surface.

### BACKGROUND OF THE INVENTION

The surface of conveyor belts must be lubricated for bottles or cans being transported on the conveyor to facilitate its circulation through the bottling line properly. Such lubrication, therefore, prevents the bottles or cans from falling off the conveyor when, for instance, a machine failure or temporary halt of the conveyor causes the bottles or cans to stop. This is true because lubrication allows for the conveyor belt to proceed in motion (in a friction-free manner) without causing the motionless bottles or cans to fall.

In the absence of appropriate lubrication, however, the conveyor belts can break or be cut, causing bottles or cans to fall, loose their contents and/or break. Moreover, due to stress, motion reducers of the conveyors would break down or burn out their coils. Thus, improperly lubricated conveyors can cause a production standstill, resulting in important economic losses in the bottling industry.

### DESCRIPTION OF THE PRIOR ART

In U.S. Pat. No. 6,688,434 a conveyor and lubricating apparatus is disclosed. A spray nozzle is employed to dispense a lubricant composition onto a conveyor surface.

A dispensing device for a lubricant composition is described in EP 1 110 025. It employs a cloth to dispense a lubricant composition onto a chain-type conveyor.

The prior art does not provide a conveyor track lubricating system which can control the humidity and homogeneity of lubrication for longer periods of time on the track surface, conveyor guides, coupling bolts and all parts of the track. Neither does the prior art provide a lubricating apparatus which can maintain the cleaning of the conveyor track with dry or semi-dry lubrication.

Accordingly, there is a need for an improved conveyor track lubricating apparatus.

The objects of the invention therefore are:

a. Providing an improved conveyor lubricating apparatus.

b. Providing a conveyor lubricating apparatus which can control the humidity and homogeneity of the lubricant.

c. Providing a conveyor lubricating apparatus which can maintain the cleaning of the track with dry or semi-dry lubricant.

d. Providing a conveyor lubricating apparatus of the foregoing type which is easily maintained.

e. Providing a conveyor lubricating apparatus of the foregoing type which can apply a lubricant with a minimum number of parts.

### SUMMARY OF THE INVENTION

The foregoing objects are accomplished and the shortcomings of the prior art are overcome in one embodiment by the combined conveyor and lubricating apparatus of this invention which includes a conveyor having a conveyor surface constructed and arranged for transporting articles on the conveyor surface, the conveyor moving from an upstream direction to a downstream direction. There is at least one dispensing device for dispensing a lubricant composition. There is at least one roller member in contact with the conveyor surface, the roller member being positioned downstream of the dispensing device and the dispensing device positioned to dispense the lubricant composition on the roller.

In one aspect, there are a multiplicity of roller members positioned in series across a width of the conveyor and a multiplicity of dispensing devices positioned upstream of the roller members.

In another aspect, the dispensing devices are positioned a distance in the range of 5 to 15 cm of the roller members and the roller members are rotatably positioned on a rod member.

In yet another aspect, the conveyor is an endless conveyor belt and the conveyor surface is composed of stainless steel.

In another embodiment, the invention provides a combined conveyor and lubricating apparatus which includes a conveyor having a conveyor surface constructed and arranged for transporting articles on the conveyor surface, and at least one combined dispensing and roller device for depositing a lubricant composition on the conveyor surface.

### DESCRIPTION OF THE DRAWINGS

FIG. 1 is top perspective view of a conveyor incorporating the lubricating apparatus of this invention;

FIG. 2 is a partial enlarged side view of the lubricating apparatus shown in FIG. 1;

FIG. 3 is a top perspective view of an alternative embodiment of the lubricating apparatus of this invention in conjunction with a conveyor; and

FIG. 4 is an enlarged sectional view of the lubricating apparatus shown in FIG. 3.

### DESCRIPTION OF THE PREFERRED EMBODIMENT

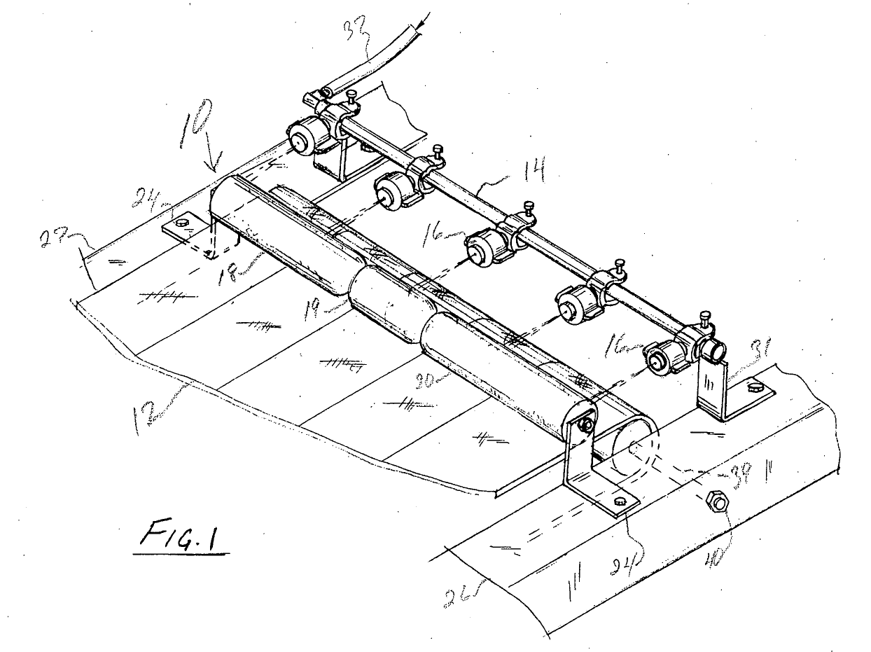

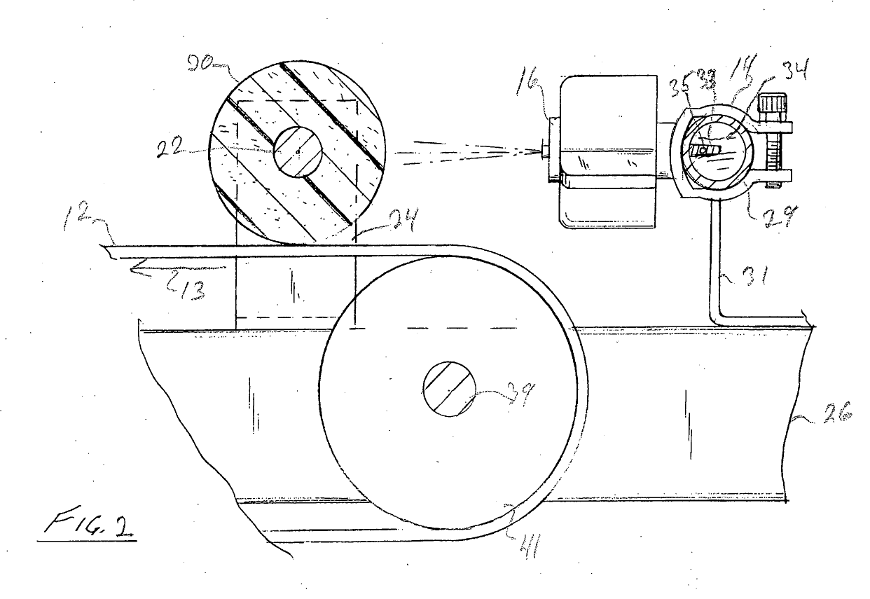

Referring to FIGS. 1 and 2, the lubricating apparatus generally 10 is shown in conjunction with a conventional endless, belt-type conveyor 12 composed of a multiplicity of belt members. It is driven by a drive roller (not shown) and moves from an upstream direction to a downstream direction as shown by arrow 13. A track lubrication dispensing device 14 includes nozzles 16 for dispensing a lubricating composition. Roller members 18, 19 and 20 are rotatably positioned on conveyor 12. They are rotatably positioned on rod members 22, which are fastened to supports 24 connected to conveyor rails 26 and 27. Dispensing nozzles 16 dispense the lubricant composition onto the roller members 18, 19 and 20.

Dispensing device 14 includes a manifold 29 with supports 31 connected to conveyor rails 26 and 27. A lubricant material 34 is fed into manifold 29 by the supply line 37. A conduit 33 conveys the lubricating material 34 from the manifold 29 to the nozzles 16 by means of the port 35.

As best seen in FIG. 2, conveyor roller 41 is rotatably supported by support rod 39. It is connected to rails 26 and 27 with nuts 40, one of which is shown in FIG. 1. It will also be seen in FIG. 2 that the dispensing device 14 is positioned at a portion of the conveyor belt 12 where the belt assumes an upper level position from a lower one.

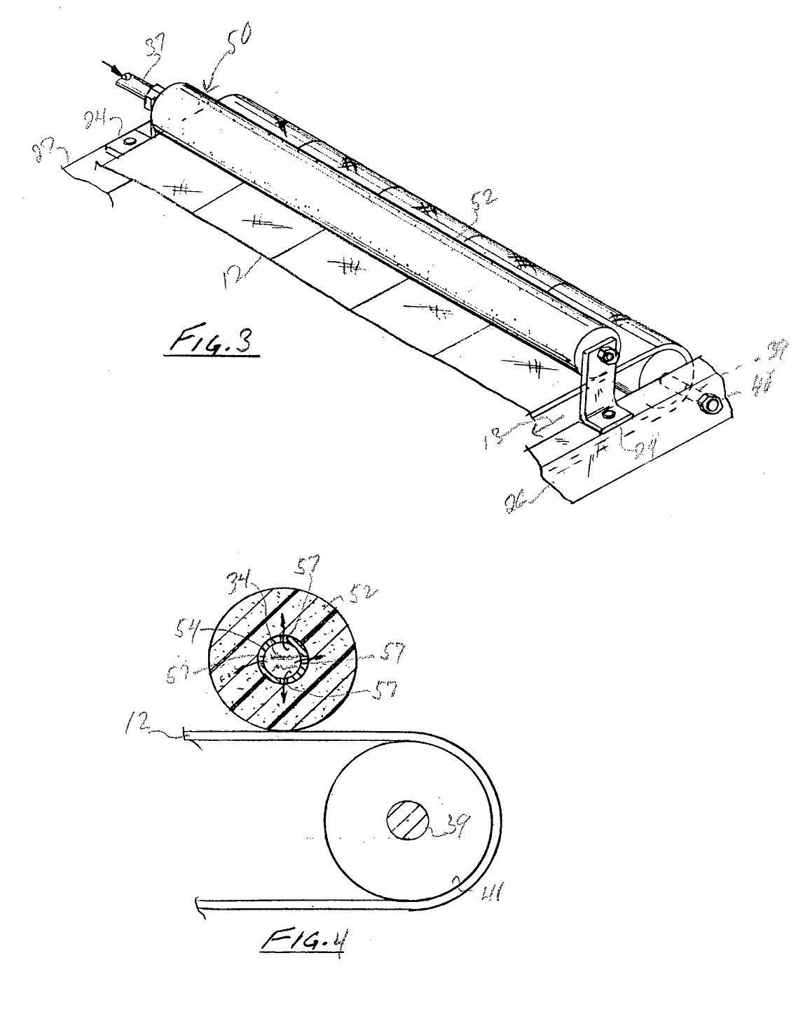

An alternative embodiment of the lubricating apparatus is shown generally at 50 in FIGS. 3 and 4. This embodiment differs from embodiment 10 in that lubricant material 34 is introduced into the inside of roller 52 by means of conduit 54 in the form of a hollow rod. There are holes 57 in conduit 54 to allow the passage of lubricant material into roller 52 for passage therethrough and onto conveyor 12. Roller 52 and conduit 54 are rotatably and sealably supported on supports 24 connected to rails 26 and 27. It will be appreciated that embodiment 50 is of a more simplified construction than embodiment 10 in that the dispensing nozzles 16 are no longer required.

The control system for introducing lubricating material into manifold 29 and conduit 23 as well as conduit 54 in roller 52 is the conventional lubricating equipment commanded with PLC, pumps, electrical valves and distribution controls.

### Operation

A better understanding of the lubricating apparatus 10 and 50 will be had by a description of their operation. Referring to FIGS. 1 and 2, conveyor 12 is put in motion by the usual drive roller (not shown) which causes conveyor belt 12 to move over conveyor roller 41. This movement also causes rollers 18, 19 and 20 to rotate. Lubricating material 34 is supplied under pressure through supply line 37, manifold 29, conduit 33, port 35 and out through nozzles 16. From nozzles 16 the lubricant material is sprayed onto rollers 18, 19 and 20 as best seen in FIG. 2. Rollers 18, 19 and 20 spread the lubricant material 34 onto the conveyor belt 12 in a uniform manner.

The operation of embodiment 50 differs from embodiment 10 in that the lubricant material 34 is applied to roller 52 from inside roller 52 rather than the outside as with nozzles 16 and rollers 18, 19 and 20.

An important feature in utilizing the rollers 18, 19, 20 and 52 is in controlling the humidity and homogeneity of lubrication for longer periods of time, as the rollers are made of absorbent materials and retain the lubricant solutions and allow them to flow to the belt 12. Another important feature is in maintaining the cleaning of the track in a dry or semi-dry lubrication. This is accomplished by the roller movement in combination with the lubricant solution to avoid the dirty build up in the belt 12 for a larger period of time.

The lubricating apparatus 10 and 50 can be used with dry, semi-dry and traditional lubricants. Lubricant compositions that can be used according to the invention can be any lubricant composition that can be dispensed through the dispensing device 14 and spread over the belt surface by the roller members 18, 19, 20 and 52. A preferred lubricant material is formulated as a combination of neutralized fatty acids, nonionic surfactants, chelating agents, antimicrobial agents and a silicon dispersion. However, the following lubricants can be employed: oil dispersions, Teflon based formulations, synthetic detergents, fatty acid formulations with or without neutralization, wax dispersions, surfactants such as ionic surfactant, cationic surfactant, ionic surfactant, amphoteric surfactant, neutralizing agents, anti-wear agents, antimicrobial agents, foam modifiers, viscosity modifiers, chelating agents, dispersing agents and carriers, used alone or in different combinations.

The preferred material for fabricating rollers 18, 19 and 20 is polyurethane. However, other materials which can be used are natural sponges, fabrics, cotton, polyester sponges, polysulphone films, polyamide films, and other materials

Lubricating apparatus 10 has been illustrated with three rollers 18, 19 and 20. Any number of rollers can be employed, depending on the size of the track. The sizes of the rollers can also be adjusted depending on the size of the track. All such and other modifications within the spirit of the invention are meant to be within its scope as defined by the appended claims.

Further, a conveyor belt comprised of stainless steel has been referred to for use with the lubrication apparatus. However, other commonly employed materials can be employed such as iron and plastic materials.

What is claimed is:

1. A combined conveyor and lubricating apparatus comprising:
a conveyor having a conveyor surface constructed and arranged for transporting articles on the conveyor surface, the conveyor moving from an upstream direction to a downstream direction;
at least one dispensing device for dispensing a lubricant composition; and
at least one roller member in contact with the conveyor surface, the roller member being positioned downstream of the dispensing device and the dispensing device positioned to dispense the lubricant composition on the roller.

2. The apparatus as defined in claim 1 wherein there are a multiplicity of roller members positioned in series across a width of the conveyor.

3. The apparatus as defined in claim 2 wherein there are a multiplicity of dispensing devices positioned upstream of the roller members.

4. The apparatus as defined in claim 3 wherein the dispensing devices are positioned a distance in the range of 5 to 15 cm of the roller members.

5. The apparatus as defined in claim 2 wherein the roller members are rotatably positioned on a rod member.

6. The apparatus as defined in claim 1 wherein the roller members are composed of polyurethane.

7. The apparatus as defined in claim 1 wherein the conveyor is an endless conveyor belt rotated over rollers and the dispensing device is positioned at a portion of the belt where the belt assumes an upper level position from a lower one.

8. The apparatus as defined in claim 7 wherein the conveyor belt is composed of a multiplicity of belt members.

9. The apparatus as defined in claim 1 wherein the conveyor surface is composed of stainless steel.

10. The apparatus as defined in claim 1 wherein the lubricant composition is composed of a combination of neutralized fatty acids, nonionic surfactants, chelating agents, antimicrobial agents and a silicon dispersion.

11. A combined conveyor and lubricating apparatus comprising:
a conveyor having a conveyor surface constructed and arranged for transporting articles on the conveyor surface; and
at least one combined dispensing and roller device for depositing a lubricant composition on the conveyor surface.

12. The apparatus as defined in claim 11 wherein there are a multiplicity of combined dispensing and roller devices.

13. The apparatus as defined in claim 1 wherein the combined dispensing and roller device includes a hollow rod with openings to feed the lubricating composition to the roller device.

14. The apparatus as defined in claim 11 wherein the roller device is composed of polyurethane.

15. The apparatus as defined in claim 11 wherein the conveyor is an endless conveyor belt.

16. The apparatus as defined in claim 15 wherein the conveyor belt is composed of a multiplicity of belt members.

17. The apparatus as defined in claim 11 wherein the conveyor surface is composed of stainless steel.

18. The apparatus as defined in claim 11 wherein the lubricant composition is a combination of neutralized fatty acids, nonionic surfactants, chelating agents, antimicrobial agents and a silicon dispersion.

19. A method of applying a lubricant to a conveyor surface employing the apparatus of claim 1.

20. A method of applying a lubricant to a conveyor surface employing the apparatus of claim 11.
